(19) United States
(12) Patent Application Publication
(10) Pub. No.: US 2026/0216882 A1
(43) Pub. Date: Jul. 30, 2026

(54) PLACEMENT HEAD FOR A PICK-AND-PLACE MACHINE

(71) Applicant: PRODRIVE TECHNOLOGIES INNOVATION SERVICES B.V., Son en Breugel (NL)

(72) Inventor: Jaimy VOS, Son en Breugel (NL)

(21) Appl. No.: 19/144,862

(22) PCT Filed: Jan. 11, 2024
(86) PCT No.: PCT/NL2024/050011

§ 371 Date: Jun. 30, 2025

(30) Foreign Application Priority Data
Jan. 25, 2023 (NL) 2034023
Mar. 1, 2023 (NL) 2034245

(51) Int. Cl. B25J 9/16; B25J 13/08; B25J 15/06

(52) U.S. Cl. CPC B25J 9/1694; B25J 13/08; B25J 15/0625

(57) ABSTRACT

A placement head includes a housing with a passageway, and a rigid handling device with a shaft portion partly received in the passageway. The housing and the shaft portion jointly define a linear bearing. The shaft portion translates along the passageway substantially parallel to the axis. A first end of the shaft portion extends from a first end of the passageway and is configured to accommodate a nozzle for holding components. A first resilient element generates a first force between the housing and the rigid handling device biasing the first end of the shaft portion away from the first end of the passageway substantially parallel to the axis of the passageway. A blocking means releasably blocks the first end of the shaft portion from moving towards the first end of the passageway. A detection device detects a magnitude of translation of the rigid handling device relative to the housing.

### TECHNICAL FIELD

The present disclosure relates to placement head for a pick-and-place machine, a manipulator for a pick, a place machine and a pick and place machine and a method for placing a component using the same.

### BACKGROUND

Pick-and-place machines are known in the art. These are for instance used for mounting electronic components on a printed circuit board (PCB). These machines pick components from a first location and place them in a second location using a placement head. A force with which such components are picked and/or placed may be limited to a pre-determined threshold to avoid damaging these components during the manufacturing-process. This may be achieved by providing a resilient element between a placement head, configured for holding and releasing a component, and the pick-and-place machine, configured for moving the placement head between a pick location and a place location, and by providing a controller configured for controlling the movement of the placement head by the pick-and-place machine, and for controlling a force exerted by the placement head on the component. Such controller is typically configured to reduce the speed of movement of the placement head in approach of the pick or place location prior to making physical contact to prevent or limit inertia from causing large perturbations in the force. Typically, such controller is further connected to a contact detection device, configured for detecting physical contact between the placement head and the pick or place location and configured for controlling a force exerted by the placement head on the component. Following the detection of physical contact, the controller controls the distance by which the placement head is displaced with respect to the pick or place location to prevent the force to exceed a predetermined value.

The controller may control the force by controlling a driving current of an actuator of the pick-and-place machine for instance by relating this to the motor force constant. This solution is suitable for predetermined thresholds of a couple of Newton and above. Over time the size of components has however continuously decreased and with that the force that may be applied to these components also has decreased. Therefore, it is required that ever smaller forces can be controlled. Controlling the driving current of the actuator to control the force is therefore not suitable for all these cases.

Small forces may be controlled more accurately by pick-and-place machines comprising a load cell. However, the inherent stiffness of such load cells requires the speed or acceleration with which the placement head is moved to be reduced even further, adversely impacting productivity and manufacturing costs. For instance, a load cell with high stiffness requires a very short stopping distance and therefore low speed, while a load cell with low stiffness requires low accelerations due to the resulting low natural frequencies.

Another known solution for controlling small forces is to provide a placement head comprising a pressure chamber with an adjustable pressure which can be adjusted to correspond to the threshold. However, using such placement heads in high productivity circumstances may result in erratic movements of parts of the placement head, which can cause excessive wear to the placement head and damage to the picked component. Furthermore, the force cannot be accurately controlled in such situations and cannot be adapted quickly because of settling times of the pressure in the pressure chamber and gas supply.

### SUMMARY

It is an object of the present disclosure to solve at least one preferably all disadvantages associated to the prior art.

According to a first aspect of the present disclosure the object of the present disclosure is achieved by a placement head according to the appended claims.

A placement head according to the present disclosure comprises a housing. The housing may comprise a passageway defining an axis along the passageway. The placement head may further comprise a rigid handling device comprising a shaft portion. The shaft portion may be partly received in the passageway (along its length). The housing and shaft portion may jointly define a linear bearing. The shaft portion may be configured to translate along the passageway substantially parallel to the axis. The housing may form a guiding part of a linear bearing and the shaft portion may form a translating part of the linear bearing, wherein the shaft portion may be configured to for instance glide or slide along the passageway. A first end of the shaft portion may extend from a first end of the passageway. The first end of the shaft portion may be configured to accommodate (e.g. releasably connect) a nozzle suitable for holding components (e.g. PCB components). The placement head may comprise a first resilient element configured to generate a first force between the housing and the rigid handling device biasing the first end of the shaft portion away from the first end of the passageway in a first direction substantially parallel to the axis. The placement head may comprise a blocking means (e.g. blocking unit or blocking mechanism) configured to releasably block the first end of the shaft portion from (substantially) moving towards the first end of the passageway in a second direction opposite the first direction. The placement head may further comprise a detection device suitable for detecting a magnitude of translation of the rigid handling device with respect to the housing substantially parallel to the axis.

Such placement head achieves the goal of the present disclosure because during a phase associated with high accelerations, such as a translocation phase wherein a component is moved (e.g. coarsely) between a pick location and a place location, the blocking means can block the movement of the shaft with respect to the housing preventing damage or loss of the picked component, while during a phase associated with low accelerations, such as a pick-and-place phase wherein a component is placed or picked, the blocking means can be released such that the first resilient element generates the first force dependent on the magnitude of translation between the rigid handling device and the housing. By detecting this magnitude of translation using the detection device the force exerted by the nozzle on the component can be accurately determined and controlled. Combined these measures therefore allow an accurate control of the placement force exerted by the nozzle in a high speed assembly environment. Furthermore, the force exerted by the nozzle can be stored for future reference, for instance to identify manufacturing parameters that may be related to issues occurring at a later moment in time.

A further benefit of such placement head is that a placement force can be accurately measured and stored for future reference, for instance to identify manufacturing parameters that may be related to issues occurring at a later moment in time.

The first resilient element may comprise a first end and a second end opposite the first end of the first resilient element. The first resilient element may be (rotatably) connected to the housing via the first end of the first resilient element such that the first end of the first resilient element and the housing translate integrally, for instance the first end of the first resilient element is fixedly connected to the housing such the first end of the first resilient element has a fixed relative position with respect to the housing. The first end of the first resilient element may be connected to the housing via a stage. The first resilient element may be connected to the shaft portion (e.g. an end plate) via the second end of the first resilient element such that the second end of the first resilient element and the shaft portion translate integrally, for instance the second end of the first resilient element is fixedly connected to the shaft portion such the second end of the first resilient element has a fixed relative position with respect to the shaft. An embodiment comprising such first resilient element has the benefit that the first resilient element can be provided away from the first end of the shaft portion.

The first resilient element may be configured such that the first force is correlated to the magnitude of translation to allow for a simple and fast way to (measure and) control the placement force. Preferably, the first resilient element may be configured such that the first force has a linear relationship with or is proportional to the magnitude of translation, to allow for a simple way to control the placement force with a substantially uniform resolution across a range of thresholds.

The first resilient element may comprise a mechanical device (e.g. a spring), a hydraulic/pneumatic device such as a first pressure chamber, for instance a (gas-tight) bellow or a piston and cylinder, and/or a magnetic device (e.g. a magnet or a voice coil). The first resilient element may be configured to be compressed or expanded when the rigid handling element is displaced relative to the housing in a direction substantially parallel to the axis, for instance in the first direction.

The blocking means may comprise a fastening means (e.g. fastener) configured for physically interacting with both the housing and the rigid handling element, such as a pin configured for engaging both the housing and the rigid handling element, or an friction fit comprising a piezoelectric element (e.g. piezoelectric motor) for providing friction between the housing and the rigid handling element.

The blocking means may be configured to provide an adaptable offset force or be configured to adapt an offset force biasing the first end of the shaft portion away from the first end of the passageway in the first direction, for instance to substantially block the movement of the rigid handling element with respect to the housing for example up to a predetermined load. The blocking means may comprise the first resilient element, wherein the blocking means is configured to adapt an offset force biasing the first end of the shaft portion away from the first end of the passageway in the first direction. Such an adaptation of the offset force may for instance be achieved by pre-loading the first resilient element. For example, the first resilient element can be compressed in embodiments, wherein the blocking means comprises a first pressure chamber (e.g. a bellow or a piston and cylinder) or a spring as the first resilient element. In another example, the pressure in the first resilient element can be increased in embodiments, wherein the blocking means comprises a first pressure chamber (e.g. a bellow or a piston and cylinder) as the first resilient element.

The blocking means may be configured to provide an adaptable resistance to deformation or configured to adapt a resistance to deformation (e.g. stiffness) of the placement head, such as an adaptable resistance to a translation of the rigid handling device with respect to the housing. The blocking means may comprise the first resilient element, wherein the blocking means is configured to adapt a stiffness of the first resilient element. For example, the first resilient element can be compressed in embodiments, wherein the blocking means comprises a first pressure chamber (e.g. a bellow or a piston and cylinder) or a spring as the first resilient element. In another example, the pressure in the first resilient element can be increased in embodiments, wherein the blocking means comprises a bellow as the first resilient element. Beneficially, operating the blocking means to block the first end of the shaft portion from moving towards the first end of the passageway in a second direction opposite the first direction, forces the rigid handling device or the shaft portion into a blocking position, wherein the first end of the shaft portion is maximally extended from the first end of the passageway.

The blocking means may be configured to adapt at least one of the offset force biasing the first end of the shaft portion away from the first end of the passageway in the first direction and the stiffness of the first resilient element. Preferably, the blocking means is configured to adapt both the offset force biasing the first end of the shaft portion away from the first end of the passageway in the first direction and the stiffness of the first resilient element.

The first resilient element may comprise a pressure chamber configured to provide an adaptable stiffness suitable to block the movement of the rigid handling element with respect to the housing. For instance, the first resilient element comprises a conduit fluidly connected to the pressure chamber, such that the conduit may be used to control a pressure in the pressure chamber by supplying gas (e.g. air) to or draining gas from the pressure chamber. A blocking means comprising such first resilient element may be configured to control a pressure in the first pressure chamber such that the stiffness of the first resilient element may be adapted dynamically, for instance during operation of handling a (single) component.

In an advantageous embodiment, the first resilient element comprises a bellow. A bellow offers the benefits of being lightweight, simple to construct and substantially frictionless during operation. Furthermore, the mechanical properties (e.g. an offset force, a stroke) of a bellow can be controlled relatively simple and fast by controlling the pressure in the bellow. This can for instance allow for controlling an offset force without impacting a stroke of the rigid handling device with respect to the housing. In one beneficial embodiment, it allows for the use of a bellow with a lower stiffness to improve a resolution of the measured force, while maintaining a placement force as an offset by increasing the pressure in the bellow. In another beneficial embodiment, it allows for the use of a bellow with a shorter nominal (i.e. unstressed) length than a clearance for housing the bellow and controlling the pressure to stretch the bellow to for instance increase a stroke, increase a resolution of the measured force or lower the impact mass. It may also be used to compensate for manufacturing tolerances of the bellow that may impact its mechanical properties. The bellow may comprise a plurality of bellows arranged in parallel (e.g. concentric) and/or in series to improve control of the mechanical properties. For instance, one of the plurality of bellows may be kept at a constant pressure as an offset, while another one of the plurality of bellow is used to control a spring rate.

In a particularly advantageous embodiment, the bellow is substantially made of one or more polymers. Using polymers for the manufacture of bellows can reduce manufacturing costs compared to for instance using a metal. Furthermore, it simplifies making small bellows that may in addition require a low stiffness. In an embodiment wherein the bellow is substantially made of one or more polymers, preferably a temperature sensor for measuring a temperature of the bellow is provided, which may be used to compensate the influence of the temperature on mechanical properties of the bellow like stiffness (e.g. spring rate).

Alternatively or additionally, the first resilient element may comprise a spring configured to provide at least one of an adaptable offset force and an adaptable stiffness.

Alternatively or additionally, the first resilient element may comprise a magnetic device configured to provide at least one of an adaptable offset force and an adaptable stiffness. For instance, by providing a magnetic device configured for controllably generating a magnetic field. Such magnetic field may result in a magnetic force acting between the housing and the rigid handling element to resist deformation of the placement head. This magnetic field may for instance be generated using a voice coil provided on one of the housing and the rigid handling device. Such magnetic field may interact with a field generated by another voice coil or a magnetic material provided on the other one of the housing and the rigid handling device.

Preferably, the linear bearing is configured as a gas bearing. In such embodiment, the linear bearing may be configured to supply gas to the control device to control the stiffness of the first pressure chamber. Such an embodiment has the benefit that the blocking means does not require an (additional) external gas supply for supplying gas to control the stiffness of the first pressure chamber.

The blocking means may comprise a gas inlet configured to supply gas to the first pressure chamber. The gas inlet may further be configured to control the pressure of the first pressure chamber. For instance, the gas inlet may comprise a (controllable) pressure valve the gas supplied to the first pressure chamber.

The blocking means may comprise a gas outlet configured to drain gas from the first pressure chamber. The gas outlet may be configured to control the pressure of the first pressure chamber. For instance, the gas outlet may comprise a (controllable) pressure relief valve to control the pressure of the first pressure chamber, such as an upper threshold of the pressure in the first pressure chamber.

The placement head may comprise a second resilient element that generates a second force biasing the first end of the shaft portion in the first direction away from the first end of the passageway. The benefit of providing such second resilient element is that the blocking means can be used to control a first force to provide an offset for the second force.

Alternatively, the placement head may comprise a second resilient element that generates a second force biasing the first end of the shaft portion in the second direction towards the first end of the passageway. The benefit of providing such second resilient element is that it can be used for compensating at least part of a weight of the rigid handling device.

Preferably, the second resilient element may be configured to generate the second force passively, for instance based on the translation. For instance, the second resilient element comprises a second spring and/or a second pressure chamber, such as a gas-tight bellow or piston and cylinder. The second pressure chamber may be configured to be compressed or expanded when the rigid handling element is displaced relative to the housing substantially parallel to the axis. The placement head or the second resilient element may be configured such that the second force is correlated to the magnitude of translation to allow for a simple and fast way to control the placement force. Preferably, the placement head or the second resilient element may be configured such that the second force has a linear relationship with or is proportional to the magnitude of translation, to allow for a simple way to control the placement force with a substantially uniform resolution across a range of thresholds. The placement head or the second resilient element may be configured to provide a stiffness and/or offset force being adaptable between a first and a second state, having the first state when handling a first component and having the second state when handling a second component.

The second resilient element may be arranged to generate the second force between the housing and the rigid handling device. The second resilient element may comprise a first end and a second end arranged opposite from the first end. The second resilient element may be connected to the housing via the first end of the second resilient element such that the first end of the second resilient element and the housing translate integrally, for instance the first end of the second resilient element is fixedly connected to the housing. The second resilient element may be connected to the rigid handling device via the second end of the second resilient element such that the second end of the second resilient element and the rigid handling device translate integrally, for instance the second end of the second resilient element is fixedly connected to the rigid handling device.

In an advantageous embodiment, the second resilient element comprises a bellow. A bellow offers the benefits of being lightweight, simple to construct and substantially frictionless during operation.

A cross section of the passageway perpendicular to the axis may have any shape, but preferably the shape of the cross section is circular or even more preferably the passageway is cylindrical. The benefit of a cylindrical passageway is that it is easy to manufacture, for instance by drilling a hole in the housing. Preferably, the housing comprises a through-hole forming the passageway, such passageway may comprise a second end arranged opposite from the first end of the passageway. Advantageously, the shaft portion has a shape corresponding to the shape of the passageway, such that a linear bearing can be formed. The passageway may fully enclose the shaft portion. Preferably, the passageway and shaft portion are configured such that the linear bearing forms a gas bearing to lower friction and reduce wear.

The shaft portion may comprise a second end arranged opposite the first end of the shaft portion. Preferably, the second end of the shaft portion extends from the second end of the passageway. The rigid handling device may further comprise an end plate attached to the shaft portion in extension of the second end of the shaft portion. The end plate may be configured to interact with the second end of the second resilient element, for instance the end plate may be configured to abut or be fixedly connected to the second end of the second resilient element. Such an embodiment has the benefit that the second resilient element is moved away from the first end of the shaft portion. The endplate may be configured to form an end stop for the shaft portion translating along the passageway, for instance for the shaft portion translating along the passageway in the first direction.

The passageway may comprise a first part and a second part. The first part of the passageway may be interposed between the first end of the passageway and the second part of the passageway. The second part of the passageway may be interposed between the second end of the passageway and the first part of the passageway. The first part of the passageway may be configured to have a first diameter. The second part of the passageway may be configured to have a second diameter. Preferably, the first diameter is larger than the second diameter.

The shaft portion may comprise a first part and a second part. The first part of the shaft portion may be interposed between the first end of the shaft portion and the second part of the shaft portion. The second part of the shaft portion may be interposed between the second end of the shaft portion and the first part of the shaft portion. The first part of the shaft portion may be configured to have a third diameter. The second part of the shaft portion may be configured to have a fourth diameter. Preferably, the first and third diameter are configured to form a first matching pair of diameters suitable to form at least part of the linear bearing. Additionally or alternatively, the second and fourth diameter are configured to form a second matching pair of diameters suitable to form at least another part of the linear bearing. The passageway and shaft portion may be configured to form a pocket (e.g. an air pocket) between a first interface of the first and second part of the passageway and a second interface of the first and second part of the shaft portion, which pocket is compressible/expandable. Preferably, the pocket forms the first pressure chamber to reduce the weight and size of the placement head.

The passageway may comprise a second end opposite to the first end of the passageway. The shaft portion may comprise a second end opposite from the first end of the shaft portion. The passageway may comprise a first part extending towards the first end of the passageway having a first diameter and may comprise a second part extending towards the second end of the passageway having a second diameter. The shaft portion may comprise a first part, extending towards the first end of the shaft portion, having a third diameter related to the first diameter, and may comprise a second part, extending towards the second end of the shaft portion, having a fourth diameter related to the second diameter. The passageway and the shaft portion may be configured to form the first pressure chamber between a first interface of the first and second part of the passageway and a second interface of the first and second part of the shaft portion. Preferable, the first diameter is larger than the second diameter.

The first end of the shaft portion may form a nozzle suitable for holding components (e.g. PCB components), comprise a nozzle or may be configured to accommodate (e.g. releasably connect) a nozzle for holding components. The latter enables replacement of the nozzle in case of wear or in case different components require different nozzles. Preferably, the first end of the shaft portion is configured to (releasably and) rigidly connect a nozzle to improve accurate control of the placement force.

The detection device may comprise any type of sensor (e.g. magnetic, capacitive or optical sensor) suitable for detecting the magnitude of translation. Such sensor may be fixedly connected to any part of the housing and/or rigid handling device. Preferably, the detection device is configured to directly detect a magnitude of translation of the end plate with respect to the housing. For instance, a sensor may be fixedly connected to a side of the housing facing the end plate and/or a sensor may be fixedly connected to the end plate, such as a side of the end plate facing the side of the housing. Such an embodiment has the benefit that the detection device is moved away from the first end of the shaft portion.

According to a second aspect of the present disclosure the object is achieved by a manipulator for a pick and place machine, comprising a placement head according to the first aspect and a base, wherein the manipulator is configured to move the placement head with respect to the base. For instance, the manipulator comprises an actuating means (e.g. actuating mechanism) connected to the base at a first end and to the placement head at a second end, the second end of the actuating means may comprise a stage (e.g. motion platform) connected to the placement head. The actuating means may be configured to move the placement head relative to the base. The actuating means may comprise an actuating device for instance comprising at least one (linear) actuator, preferably a plurality of (linear) actuators. The actuating means is for instance configured to move the placement head substantially parallel to the axis (e.g. in the first direction) with respect to the base. To that end, the actuating means may comprise a first actuator, such as a linear actuator oriented in parallel to the axis. Preferably, the actuating means is further configured to move the placement head relative to the base in a plane orthogonal to the axis, such that the placement head can be moved within a volume. The actuating means may therefore comprise a plurality of actuators configured to move the placement head. The actuating means may for instance comprise a second and a third linear actuator, which in conjunction with the first linear actuator form three orthogonal linear actuators configured to move the placement head along three orthogonal axes. Preferably, the second end of the actuating means is connected to the housing of the placement head such that the second end and the housing translate integrally.

The second end of the actuating means may comprise a rotary actuator to align a picked component with respect to a placement location. Such rotary actuator may be connected to the first resilient element such that the first end of the shaft portion can be rotated about the axis relative to the housing. For instance, a stationary part of the rotary actuator may be fixedly connected to the second end of the actuating means and a rotating part of the rotary actuator may be fixedly connected to the first resilient element (e.g. the first end of the first resilient element).

The manipulator may further comprise a control unit connected to the blocking means. The control unit may be configured to control the blocking means between a blocked state and a released state. For instance, the blocking means in the blocked state generates a first force blocking the rigid handling device or the shaft portion from translating along the passageway. In the released state, the blocking means is configured to enable movement of the rigid handling device or the shaft portion with respect to the housing. For instance, the blocking means in the released state generates a first force allowing the shaft portion to translate along the passageway. Preferably, the first force in the blocked state is higher than the first force in the released state. In the blocked state, the blocking means may be configured to hold the rigid handling device or the shaft portion in a blocking position. Beneficially, the first end of the shaft portion is maximally extended from the first end of the passageway in the blocking position. The benefit of such a manipulator is that it enables large accelerations of the placement head in the locked state, while enabling accurately measuring small forces in the released state.

The control unit may further be configured to control the movement of the stage for moving the placement head in a translocation phase and in a pick-and-place phase. In the translocation phase the placement head may be translocated between a pick and a place location. In the pick-and-place phase the placement head may perform one of picking and placing a component at the pick and the place location, respectively. The control unit may further be configured to maintain the blocked state during the translocation phase and may be configured to maintain the released state during the pick-and-place phase. This enables the large movements in the translocation phase to be executed with high accelerations, while enabling accurately measuring small forces in the pick-and-place phase. The benefit of such a manipulator is that it allows for increasing productivity without increasing the risk for damaging the component or placement head, or loss of the component due to erratic movements of the rigid handling device with respect to the housing.

The control unit may further be connected to the detection device (e.g. a measurement device). Such control unit may be configured to stop moving the stage in the first direction once the magnitude of translation has reached a predetermined threshold to avoid damaging the component. Preferably, the control unit is configured to stop moving the stage in the first direction during the pick-and-place phase

According to a third aspect of the present disclosure the object is achieved by a pick-and-place machine comprising a placement head according to the first aspect or a manipulator according to the second aspect.

According to a fourth aspect of the present disclosure the object is achieved by a method for placing a component using a placement head according to the first aspect, a manipulator according to the second aspect or a pick-and-place machine according to the third aspect, which method comprises the steps of operating the blocking means to block the shaft portion from translating with respect to the housing, in which the placement head is translocated between a pick and a place location, and operating the blocking means to release the shaft portion to enable the shaft portion to translate along the passageway during a pick-and-place phase, in which the placement head performs one of picking and placing a component at the pick and the place location, respectively. Preferably, the shaft portion is (maintained) in the blocking position during the translocation phase.

### BRIEF DESCRIPTION OF THE DRAWINGS

Aspects of the present disclosure will now be described in more detail with reference to the appended drawings, wherein similar reference numerals illustrate similar features and wherein:

FIG. 1A represents a cross section of a first embodiment of a placement head according to the present disclosure with the rigid handling device in a blocked state.

FIG. 1B represents a cross section of a first embodiment of a placement head according to the present disclosure with the rigid handling device in a released state.

FIGS. 2A and 2B represent a cross section of a second embodiment of a placement head according to the present disclosure in a released state.

FIG. 3A-C represent a cross section of a first embodiment of a manipulator according to the present disclosure in various stages of placing a component.

### DETAILED DESCRIPTION

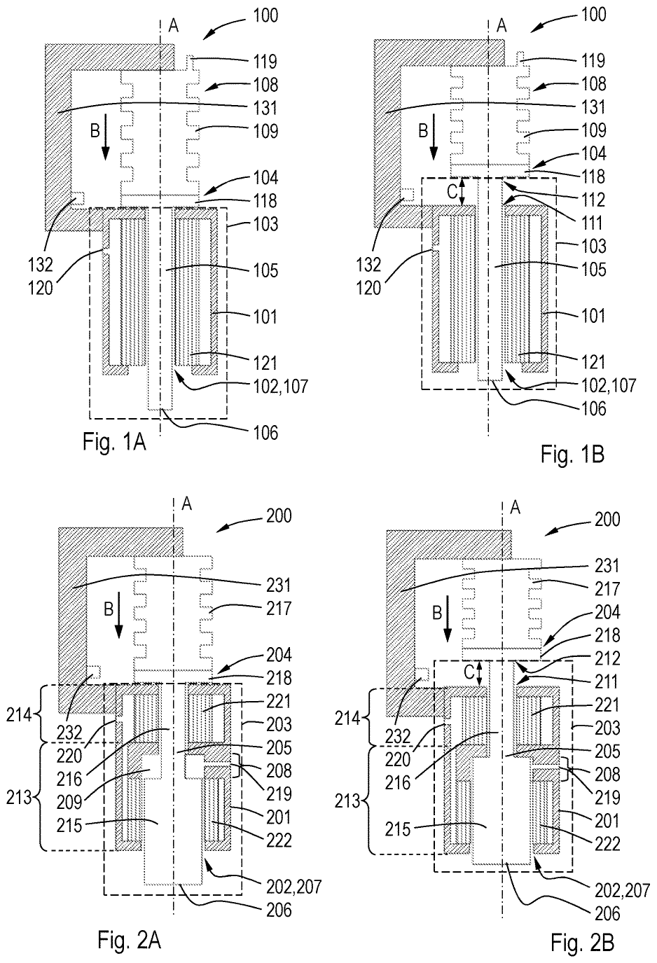

Referring to FIGS. 1A, 1B, 2A and 2B, a placement head 100, 200 comprises a housing 101, 201. The housing typically forms one of the connecting elements between the placement head and a stage of a pick-and-place machine. The housing 100, 200 comprises a through hole forming a passageway 102, 202. The passageway 102, 202 extends between a first aperture of the housing, which forms a first end 107, 207 of the passageway 102, 202, and a second aperture of the housing opposite to the first aperture, which forms a second end 111, 211 of the passageway 102, 202. The passageway defines an axis A and forms a guiding part of a linear bearing 103, 203. Preferably, the passageway has a cylindrical shape.

The placement head 100, 200 further comprises a rigid handling device 104, 204 through which the placement head 100, 200 interacts (e.g. via a nozzle) with components. The rigid handling device 104, 204 comprises a shaft portion 105, 205 being partly received in the passageway 102, 202 and comprising a first end 106, 206 extending from the first end 107, 207 of the passageway 102, 202. The shaft portion 105, 205 is configured to translate along the passageway 102, 202 and forms a translating part of the linear bearing 103, 203.

The linear bearing being formed by the passageway 102, 202 and the shaft portion 105, 205 may be configured to form a gas (e.g. air) bearing. In such embodiments, the housing 100, 200 may comprise a porous substrate 121, 221, 222 lining at least part of the passageway 102, 202 and forming a chamber between the housing 100, 200 and the porous substrate 121, 221, 222. The substrate may comprise a material being naturally porous or a material being made porous, for instance by some method of drilling. The housing may further comprise a gas inlet 120, 220 configured to supply gas to the chamber. This enables equally distributing the supplied gas across the gas bearing. The supplied gas can escape the gas bearing via the first end 107, 207 and the second end 111, 211 of the passageway 102, 202. As an alternative to a gas bearing, the linear bearing may be equipped with other types of means for guidance (e.g. linear and/or rotational), such as leaf springs (flexures), ball bearings, ball guides. For instance, the passageway 102, 202 may comprise at least one leaf spring for guiding the shaft portion 105, 205.

Typically, the first end 106, 206 of the shaft portion 105, 205 is configured to accommodate a nozzle suitable for holding components. To that end, the shaft portion 105, 205 may comprise a suction passage extending towards the first end 106, 206 of the shaft portion 105, 205. For instance, the shaft portion 105, 205 comprises a through hole being arranged parallel to the axis A and being configured to form the suction passage.

The shaft portion 105, 205 comprises a second end 112, 212 arranged opposite from the first end 106, 206. The second end 112, 212 of the shaft portion 105, 205 extends from the second end 111, 211 of the passageway 102, 202. However, other embodiments wherein the second end 112, 212 of the shaft portion 105, 205 does not extend from an (optional) second end 111, 211 of the passageway 102, 202.

An end plate 118, 218 is connected to the second end 112, 212 of the shaft portion 105, 205. The end plate 118, 218 is configured to from an end stop for the shaft portion 105, 205 translating along the passageway 102, 202 in the first direction B. The housing may comprise a thrust bearing (e.g. ball bearing, air bearing) being provided between the housing and the end plate, enabling the shaft portion to rotate with low friction with respect to the housing.

The placement head 100, 200 further comprises a blocking means 108, 208. The blocking means 108, 208 comprises a first resilient element 109, 209 configured to generate a first force biasing the first end 106, 206 of the shaft portion 105, 205 in a first direction B substantially parallel to the axis away from a first end 107, 207 of the passageway 102, 202. The blocking means 108, 208 may be configured to actively control the first force, for instance by actively controlling a stiffness of the first resilient element 109, 209 such that a contribution of the first resilient element 109, 209 to a total stiffness and a total biasing force can actively be controlled. For instance, the first resilient element 109, 209 comprises a first pressure chamber and the blocking means 108, 208 is configured to control a pressure in the first pressure chamber 109, 209. To that end, the control device may comprise a conduit 119, 219 forming a gas inlet and/or a gas outlet configured to control the pressure in the first pressure chamber.

The first pressure chamber may be arranged away from the linear bearing. In one example (see FIGS. 1A and 1B), the first pressure chamber 109 comprises a bellow, which is arranged at a side of the end plate 118 facing away from the second end 112 of the shaft portion 105. The end plate 118 abuts a first end of the bellow. A second end of the bellow arranged opposite the first end of the bellow is preferably (fixedly) connected to the housing 101, for instance via a bracket 131 which is fixedly connected to the housing 101 or a bracket that forms an integral part of the housing 101. The bracket 131 may form a junction configured for connecting the housing 101 to a stage. The pressure in the bellow can be controlled by supplying and/or draining gas via conduit 119.

Alternatively, the linear bearing may be configured to form the first pressure chamber. For instance, the cross-sectional area of the linear bearing changes along the axis A to define a pocket (e.g. an air pocket) between the passageway and shaft portion, which pocket forms the first pressure chamber. In one example (see FIG. 2A and B), the housing 201 comprises a passageway, wherein a first part 213 of the passageway 202 has a first diameter and wherein a second part 214 of the passageway 202 having a second diameter being larger than the first diameter. Furthermore, the shaft portion 205 comprises a first part 215 having a third diameter, which first part 215 overlaps the first part 213 of the passageway 202, and a second part 216 having a fourth diameter, which second part 216 overlaps the second part 214 of the passageway 202. The third and fourth diameter correspond to the first and second diameter, respectively, such that a linear bearing can be formed by the passageway 202 and the shaft portion 205. The pressure in the pocket can be controlled by supplying and/or draining gas via conduit 219 and/or gas inlet 221.

By supplying gas to the first pressure chamber 109, 209 in any of the two previous examples, the pressure in the first pressure chamber is increased. This forces the rigid handling element 104, 204 in the first direction B with respect to the housing 101, 201 and increases the stiffness of the placement head 100, 200.

The placement head may comprise a second resilient element, such as a second spring or second pressure chamber (e.g. a second bellow), to generate a second force biasing the first end of the shaft portion in the first direction away from the first end of the passageway. Such second resilient element may be arranged away from the linear bearing. In one example (see FIGS. 2 and 2B), the second resilient element comprises a bellow 217, which bellow is arranged at a side of the end plate 218 facing away from the second end 212 of the shaft portion 205. The end plate 218 abuts a first end of the bellow 217. A second end of the bellow 217 arranged opposite the first end of the bellow 217 is preferably (fixedly) connected to the housing 201, for instance via a bracket 231 which is fixedly connected to the housing 201 or a bracket that forms an integral part of the housing 201. The bracket 231 may form a junction configured for connecting the housing 101 to a stage.

The placement head 100, 200 further comprises a detection device 132, 232 configured for detecting a magnitude of translation C of the rigid handling device 104, 204 with respect to the housing 101, 201 substantially parallel to the axis A. For instance, the detection device comprises a sensor (e.g. magnetic, capacitive or optical sensor) connected to the housing and being configured to detect a magnitude of translation of the end plate 118, 218.

Referring to FIGS. 1A and 2A, in a locked state the pressure in the first resilient element 109, 209 is increased to the extent that the end plate 118, 218 is forced to abut the housing 101, 201. The end plate 118, 218 in this state forms an end stop preventing the shaft portion 105, 205 to translate further along the passageway 102, 202 in the first direction. In this state, the shaft portion 105, 205 is maximally extended from the first end 107, 207 of the passageway 102, 202. This locked state is used when the placement head is moved in the translocation phase, which phase is associated with high-speed movements and more importantly high accelerations and decelerations. The pressure is typically chosen such that during the translocation phase the end plate 118, 218 keeps abutting the housing 101, 201.

Referring to FIGS. 1B and 2B, in a released state the end plate 118, 218 is allowed to move away from the housing 101, 201, such that the shaft portion 105, 205 can translate along the passageway 102, 202 in a second direction opposite the first direction. This movement of the shaft portion 105, 205 with respect to the passageway 102, 202 causes the first resilient element 109, 209 to be compressed. This released state is used when the placement head is moved in the pick-and-place phase, which phase is associated with low-speed movements and more importantly low accelerations and decelerations. Once the rigid handling device impacts an external surface (e.g. the surface of a PCB via a component) the shaft portion 105, 205 translates along the passageway 102, 202 in a second direction opposite the first direction. The resulting magnitude of translation C in combination with the controlled stiffness and optionally any additional stiffness for instance introduced by a second resilient element then forms a measure for the force exerted on the external surface (e.g. placement force). In FIGS. 2A and 2B the placement head is shown in the situation where the magnitude of translation is maximal.

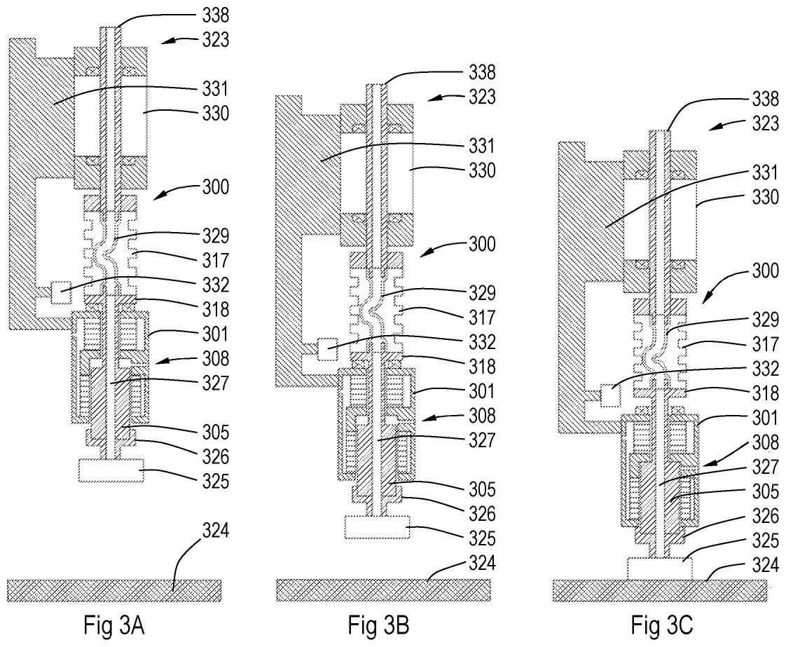

Referring to FIGS. 3A and 3B, a placement head 300 resembling the placement head shown in FIGS. 2A and 2B is connected to a stage 331 and jointly form (part of) a manipulator 323. The housing 301 is fixedly connected to the stage 331 via a first junction of the stage 331. The stage 331 further comprises a second junction comprising a rotary actuator 330 connected to the shaft portion 305 via a (rigid) conduit 328 and a second resilient element 317. The stage 331 is typically moved through a volume using a plurality of linear actuators (not shown). A component 325 can be placed on PCB 324 by moving the placement head 300 in the first direction towards the PCB 324.

A (flexible) conduit 329 provided inside the second resilient element 317 fluidly connects the (rigid) conduit 328 to a suction passage 327 provided in the shaft portion 305. The first end of the shaft portion 305 is connected to a nozzle 326, which nozzle is configured to pick-up and hold a component 325 using gas pressure (e.g. vacuum) applied to the (rigid) conduit 328 by for instance a pneumatic system (not shown) and to place the component 325 on a PCB 324 using gas pressure (e.g. compressed air) applied to the (rigid) conduit 328 by for instance the pneumatic system (not shown).

A detection device 332 is attached to the stage. The detection device 332 is configured to detect a magnitude of translation of an end plate 318 of the shaft portion 305 with respect to the stage and therefore directly detects a magnitude of translation of the shaft portion 305 with respect to the housing.

During the translocation phase (see FIG. 3A), the component is still relatively far removed from the PCB. In this phase, the blocking means is in a blocked state. In this state the relative position of the rigid handling element with respect to the housing is locked by generating a high pressure in the first resilient element. Locking this relative position allows the stage 331 to be moved with high accelerations.

When the component 325 approaches the PCB 324, the pick-an-place phase commences (see FIG. 3B). In this phase, the blocking means is in a released state. In this state the rigid handling element is allowed to move with respect to the housing by reducing (or preferably releasing) the pressure in the first resilient element. During this phase the accelerations of the stage 331 are limited to prevent damage to the component 325 and/or placement head 300. The accelerations are preferably limited to prevent the shaft from moving with respect to the housing as a result of the accelerations. This may be achieved by limiting the accelerations such that the force it generates does not exceed the force keeping the shaft in place with respect to the housing, which force is for instance generated by the blocking means, the second resilient element 317, gravity and/or inertia.

Once contact is made between the component 325 and the PCB 324 (see FIG. 3C), the shaft portion 305 is displaced with respect to the housing 301 in a direction opposite the first direction (see FIG. 3B). Consequently, the end plate 318 is displaced with respect to the detection device 332 and the resilient elements are compressed accordingly, resulting in the translation being directly related to the placement force. Therefore, detecting the translation by the detection device 332 enables a precise control of the placement force.

1. A placement head for a pick-and-place machine, the placement head comprising
a housing comprising a passageway defining an axis;
a rigid handling device comprising:
a shaft portion partly received in the passageway, wherein the housing and the shaft portion jointly define a linear bearing, wherein the shaft portion is configured to translate along the passageway substantially parallel to the axis, and wherein a first end of the shaft portion extends from a first end of the passageway,
wherein the first end of the shaft portion is configured to accommodate a nozzle suitable for holding components;
a first resilient element configured to generate a first force between the housing and the rigid handling device biasing the first end of the shaft portion away from the first end of the passageway in a first direction substantially parallel to the axis;
a blocking means configured to releasably block the first end of the shaft portion from moving towards the first end of the passageway in a second direction opposite the first direction; and
a detection device configured to detect a magnitude of translation of the rigid handling device with respect to the housing substantially parallel to the axis,

2. The placement head according to claim 1, wherein the blocking means comprises the first resilient element and wherein the blocking means is configured adapt at least one of an offset force biasing the first end of the shaft portion away from the first end of the passageway in the first direction and a stiffness of the first resilient element.

3. The placement head according to claim 2, wherein the first resilient element comprises a first pressure chamber, and wherein the blocking means is configured to control a pressure in the first pressure chamber.

4. The placement head according to any one claim 1, wherein the passageway comprises a second end opposite to the first end of the passageway, and wherein the shaft portion comprises a second end opposite from the first end of the shaft portion, wherein the passageway comprises a first part extending towards the first end of the passageway having a first diameter and a second part extending towards the second end of the passageway having a second diameter, wherein the shaft portion comprises a first part extending towards the first end of the shaft portion having a third diameter related to the first diameter and a second part extending towards the second end of the shaft portion having a fourth diameter related to the second diameter, wherein the passageway and the shaft portion are configured to form a first pressure chamber between a first interface of the first and second part of the passageway and a second interface of the first and second part of the shaft portion.

5. The placement head according to claim 4, wherein the first diameter is larger than the second diameter.

6. The placement head according to of the previous claim 1, wherein the placement head further comprises a second resilient element wherein the second resilient element is configured to generate a second force biasing the first end of the shaft portion in the first direction.

7. The placement head according to claim 6, wherein the second resilient element comprises at least one of a spring and a second pressure chamber.

8. The placement head according to claim 1, wherein the first resilient element is connected to the housing via a first end of the first resilient element and wherein the first resilient element is connected to the shaft portion via a second end of the first resilient element arranged opposite from the first end of the first resilient element.

9. The placement head according to claim 1, wherein the passageway comprises a second end opposite to the first end of the passageway, and wherein the shaft portion comprises a second end opposite from the first end of the shaft portion, wherein the second end of the shaft portion extends from the second end of the passageway, wherein the rigid handling device further comprises an end plate connected to the shaft portion in extension of the second end of the shaft portion and wherein the detection device is configured to directly detect a magnitude of translation of the end plate with respect to the housing, resilient element and an end of the second resilient element.

10. A manipulator for a pick and place machine, the manipulator comprising:
the placement head of claims, claim 1;
a base; and
an actuating means connected to the base at a first end and to the placement head at a second end;
wherein the actuating means is configured to move the placement head relative to the base.

11. The manipulator according to claim 10, further comprising a control unit connected to the blocking means, wherein the control unit is configured to control the blocking means between a blocked state, wherein the shaft portion is blocked from translating with respect to the housing, and a released state, wherein the shaft portion is released for translating with respect to the housing parallel to the axis.

12. The manipulator according to claim 11, wherein the control unit is configured to control the actuating means in a translocation phase, in which the placement head is being translocated between a pick and a place location, and in a pick-and-place phase, in which the placement head performs one of picking and placing a component at the pick and the place location, respectively, wherein the control unit is further configured to maintain the blocked state during the translocation phase and to maintain the released state during the pick-and-place phase.

13. The manipulator according to claim 11, wherein the control unit is further connected to the detection device, and wherein the control unit is configured to stop moving the placement head in the first direction once the magnitude of translation has reached a predetermined threshold, preferably wherein the second end of the actuating means

14. A pick-and-place machine comprising the placement head of claim 1.

15. A method for placing a component using the placement head of claim 1, the method comprising:
operating the blocking means to block the shaft portion from translating with respect to the housing during a translocation phase, in which the placement head is translocated between a pick and a place location, and
operating the blocking means to release the shaft portion to enable the shaft portion to translate along the passageway during a pick-and-place phase, in which the placement head performs one of picking and placing a component at the pick and the place location, respectively.

16. The placement head according to claim 3, wherein the blocking means is configured to supply gas to the linear bearing.

17. The placement head according to claim 6, wherein the second resilient element is configured to generate the second force passively.

18. The placement head according to claim 9, wherein the end plate abuts at least one of a second end of the first resilient element and an end of the second resilient element.

19. The manipulator of claim 13, wherein the second end of the actuating means comprises a stage connected to the placement head and wherein the control unit is configured to stop moving the stage in the first direction during the pick-and-place phase.

20. A pick-and-place machine comprising the manipulator of claim 10.
